(19) United States
(12) Patent Application Publication
(10) Pub. No.: US 2003/0093319 A1
(43) Pub. Date: May 15, 2003

(54) Essential bill reduction system and method

(76) Inventor: Paul Jarman, Salt Lake City, UT (US)

Correspondence Address: Steve M. Perry, THORPE NORTH WESTERN, P.O. BOX 1219, Sandy, UT, 84070-1219, US

(21) Appl. No.: 10/295,078

(22) Filed: Nov. 14, 2002

Related U.S. Application Data
(60) Provisional application No. 60/332,402, filed on Nov. 14, 2001.

(51) Int. Cl. G06F 17/60

(52) U.S. Cl. 705/14; 705/26; 705/34; 705/40

(57) ABSTRACT

A system and method for reducing and potentially eliminating a monthly bill for services subscribed to by members of a shopping club. Shopping club members join a shopping club and subscribe to a subscriber service such as an information service, long distance service or Internet service that is offered by the shopping club. The shopping club members are then referred to sales partners, who provide a rebate to the shopping club for purchases made by the shopping club member through the sales partners. A rebate is received by the shopping club from sales partners for purchases made by the shopping club member. The rebate from the sales partner is applied as a credit to the shopping club member's periodic bill for subscriber services. If rebates received from the sales partners exceed the shopping club member's monthly bill for monthly subscriber services, a payment is paid to shopping club member.

Priority of provisional application No. 60/332,402 filed Nov. 14, 2001 in the US Patent Office is hereby claimed.

### SPECIFICATION

1. Field of the Invention

The present invention relates generally to a system and method for reducing or eliminating a monthly bill for essential services. More particularly, the present invention relates to reducing or eliminating a periodic bill for essential or subscriber services through rebates from purchases.

2. Background

New technologies are increasing the demand for personal and business communication services. Online shopping growth and the economic environment have created a ripe marketplace for obtaining telecommunication customers if the appropriate level of value and services are provided to customers. The total telecommunication services market revenue is expected to grow at a high annual growth rate over the next several years in the United States, reaching a size of hundreds of billions of dollars. Data and wireless services are expected to be the highest areas of growth.

On another front, the battle for residential communication customers has been raging over the past several years. Companies such as AT&T, MCI WorldCom and Sprint have been engaged in a very aggressive price war, dropping rates by huge margins in many cases. However, these three companies that collectively share the majority of the domestic residential long-distance market, have recently decided to reduce their focus on the residential segment and concentrate more of their marketing muscle on new technologies and business customers.

This development opens a tremendous window of opportunity for companies who desire to obtain customers in this area. Not only has the marketplace become less crowded, but pricing has also stabilized. This allows smaller companies to market to customers that are less influenced by the courting and sales tactics of major brands. As the information age continues to mature, consumers are becoming more relationship-oriented. The days of terrible customer service and neglecting customers by leaving them on high rate utility plans will soon be over. Consumers will flock to organizations that earn their loyalty through constant benefits and personalized service. They will become members of organizations that help them save money through the collective buying power of the group.

There is a great opportunity to earn the loyalty of monthly service consumers for the long-term. Better customer service and member benefits are the key to a long and profitable relationship with consumers. Most of the giant monthly service companies have created customer-bases that are disloyal, which opens up an opportunity for companies that are more consumer-focused.

In addition to the changes in the telecommunications industry, research indicates that many of Internet users will soon be shopping through organizations that help them get more for their money. Online spending is projected to reach into the trillions by 2004.

With an uneasy economy in the making, or even a continued stable economy, there are many consumers that are looking to save money and companies who provide those savings will attract those customers. Companies who provide the appropriate savings and service will attract customers and have a recession-proof business model. Only companies who provide world-class customer service, consolidated billing, and consistent savings opportunities will keep their customers content.

In order to gain new members and market effectively to them, companies needs to understand and profile current customers. The Internet has created a new economy in many regards.

An important issue for companies in the future is being able to acquire and retain loyal customers who will spend money on the company's product. In addition, companies must also find ways to capture a part of the expanding market inherent to online shopping.

### BRIEF DESCRIPTION OF THE DRAWINGS

FIG. 1 is a flow chart illustrating the steps in a method to reduce or eliminate a bill for essential services for a shopping club member as in the system of FIG. 1;

FIG. 2 is a block diagram illustrating a system and method for providing rebates to a shopping club member to reduce and eliminate a bill for essential services.

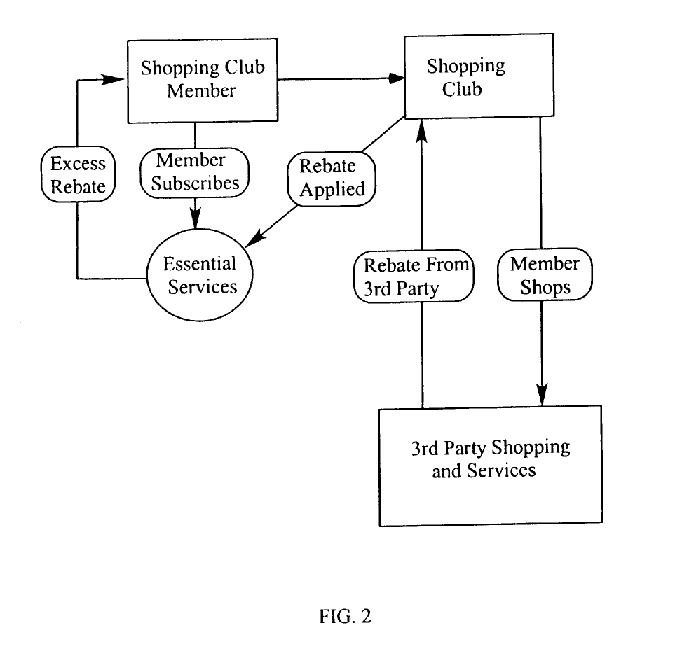

### DETAILED DESCRIPTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

A shopping club (or buyer's club) allows individuals and businesses to join a consumer membership organization that offers discounts on periodic or monthly services. In addition, the shopping club offers rebate programs to help its membership reduce, eliminate or “zero-out” their monthly bills for many essential services, such as residential and commercial telephone service, Internet service, cellular service, etc. These essential services are provided through the shopping club.

The present invention has significant advantages over what has existed previously. First, this invention offers the unique advantage of the reducing or eliminating monthly bills and expenses. This reduction in bills enhances customer loyalty. In addition, it provides an approach to bundling a consumer's monthly services such as residential and commercial telephone services, cellular phones, etc. (referred to as the “essential services”). This means that a consumer or shopping club member is likely to buy more types of essential services from one source.

Another important advantage of organizing a shopping club or buyers group is that a shopping club system can channel the consumer's online spending activity through shopping incentives. The shopping club uses the collective buying power of its aggregate membership to offer recurring monthly essential services to each of its members at discount prices. Exclusive member benefits, in the form of online shopping and referral rebates, enable the member to have alternative payment sources for the essential services. This eliminates or “zeros-out” these recurring monthly bills. The information provided by a member when they join the organization also provides enhanced member profiling to create long-term revenue stream.

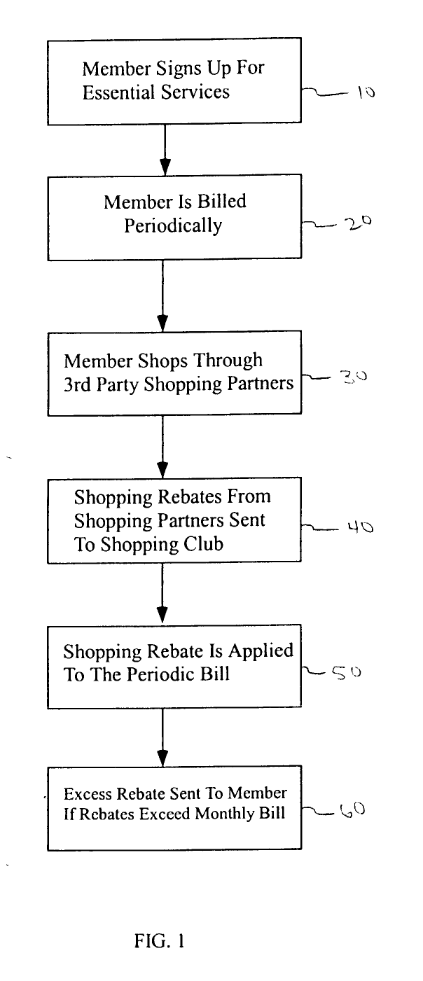

A shopping club is a membership-based sales and marketing company focusing on providing essential services and products. Referring now to FIG. 1, a summary of the steps for reducing the periodic service charges incurred for essential services and products is illustrated. The first step is a member signs up for or subscribes to the essential services through the shopping club 10. Accordingly, this makes them a shopping club member. The shopping club provides these services and products or it may contract with another service organization to provide these services for the shopping club. The next step is that the shopping club bills the member periodically for the essential services and products received 20. The shopping club member may be billed monthly, bi-monthly, semi-monthly or in other periodic time increments.

After the shopping club member has subscribed to one or more services or products, the shopping club provides mechanisms to reduce the bill for essential services through rebates. In this step, the member is directed to shopping partners who provide rebates to the shopping club for purchases made by shopping club members 30. The shopping club members are preferably referred to the shopping partners through the shopping club's web site. Referrals and rebates through the web site are simple to track (as explained later) and many Internet shopping sites already pay rebates to an originating web site for customer referrals. Referrals may also be made through a printed directory, catalog, telephone contact, email, or similar direct contact mechanisms. In any case, the system must be able to track which shopping club member a rebate belongs to.

FIG. 1 illustrates that after the shopping club member has purchased a product or service from one or more shopping partners, rebates for those purchases are sent to the shopping club 40. The transfer of the rebates is performed electronically as described in detail later. The shopping club then applies the rebates to the shopping club member's periodic bill 50. When the rebate that is applied to the shopping club member's bill exceeds the total amount of the bill, then the excess rebate is sent to the shopping club member 60. For example, a shopping club member may have a $50 a month long distance bill for the long distance service received through the shopping club. Then the shopping club member purchases an $800 video camera from a shopping partner and receives a $40 rebate. This rebate is received by the shopping club and applied to the member's bill, which leaves the member with only a $10 bill. If more rebates are received, then the member will have no bill or they may even receive a rebate.

The essential services and products that the shopping club can offer range from telecommunications services to grocery rebates programs. Telecommunications services offered by the shopping club can include a complete line of voice and data telecommunication services such as long-distance, calling cards, and data-transfer connectivity (e.g., T1 lines). Internet-centric services may include Internet connection services for residential and business consumers, web hosting, and web development services. Other services that may be provided are wireless communications, broadband Internet access, satellite television, home security, utilities, grocery delivery, and a monthly grocery savings services. Other products and/or services may be added if they use a subscription payment model. The shopping club system purchases these services at wholesale prices and re-sells them to its membership, generating a gross profit margin. The shopping club system preferably offers its services, such as a long distance and/or Internet service at highly competitive rates.

One advantage of this invention is a motivating business model that incorporates the use of online shopping rebates that are applied to the cost of the essential services and products provided by the shopping club to its members. Thus, members can potentially zero-out their monthly bills. If enough shopping takes place through the shopping club's affiliated partners, members may receive a refund check for any rebates earned beyond the amount of their monthly bill.

Vendors are attracted to the shopping club because of its large and ever-growing membership who are encouraged to shop with affiliated online stores in order to reduce their monthly essential services costs. The overall shopping rebate process encourages vendors to offer discounts to shopping club members, who will then desire to shop at the vendor's online stores. This amounts to a significant customer volume to which vendors might not otherwise have access.

The shopping club provides a link to vendors' online stores from its web site. The site is available to anyone, not just members. However, only members receive rebates. Rebates are always applied to the members' services invoice before being paid directly to the member. Shoppers who elect not to join the shopping club are allowed to shop in affiliate stores, but all shopping rebates become the property of the shopping club.

When members purchase products from affiliated vendors, the vendors keep track of the purchase and apply the contracted rebate percentage to the cost of goods purchased. The shopping club receives that data in one of two ways. In the first situation, the data collection for shopping club members is vendor initiated. As a part of the contract with the shopping club, vendors agree to track the purchases of all the shopping club members.

Independent vendors are required to collect the shopping data into flat files, and then provide the shopping club with those files at least once a month. They send their files via FTP to a “landing zone” specified by the shopping club or by sending the file to the shopping club as an email attachment. That data is inserted into the shopping club accounting program's database.

In the second situation, the shopping club initiates the data collection for member's purchases. This way major online malls are not required to submit shopping club data to the buyer's for their mall stores. Instead, the shopping club uses proprietary web-based “spiders” which go to the vendor's site and parse the HTML pages or execute database queries for the shopping data. Major online malls (e.g., LinkShare, Commission Junction, etc.) give permission for the shopping club to run Perl-based spiders to extract pertinent purchase data from an HTML page or database on the vendor's site.

The rebate data is automatically aggregated and entered into the shopping club databases where it is then applied to members' service invoices. The periodic invoices can then be displayed online and/or mailed to members. P Data files that are collected from the shopping club via the “landing zone” or via “spiders” are aggregated and inserted into the accounting database by an automated process called the “purchase-loader”. The purchase-loader uses a timed function to run each day. The time-activated program checks the “landing zone” for flat files. If any files are found, they are parsed for the appropriate data that is then inserted into the accounting database. If the files have been incorrectly formatted information or there are other content concerns, an automated error process marks the problem data for manual correction. Data collected via email is manually entered into the database.

Once the data is in the accounting database, the accounting program applies the shopping rebates received from shopping partners to the monthly service cost. The balance of the bill is sent as an invoice to the shopping club member. When the rebate is larger than the service bill, the member is provided with a rebate check. In the preferred embodiment of this invention, a rebate check is provided to the member only if the amount is equal to or greater than $100. The rebate check threshold may be set to a level the shopping club determines is appropriate. Setting a rebate threshold allows shopping credits to be carried over for members who only have a small amount of rebates. Rebates carried over from the previous month are applied against the next months service bill

When the shopping rebate data is inserted into the accounting database, it is stored in a staging table with a status of “P” for pending. Member rebates are provided via a payment-processing program, which verifies that the data is in a usable format. If the entries are in the correct format, the rebate status is changed to “R” (for Ready to Process) and the rebate is applied to the member's account as a payment. If the account entry is not in an approved format, the rebate status is changed to “N” (for Not Approved) and it remains in that status until the record is manually approved.

The electronic presentation of a member's account and invoices aids in the organization of an efficient shopping club system. The shopping club discourages paper-based billing by offering the ability for a member to view invoices online. Internet enabled programs (e.g., Java, ActiveX, etc.) allow the member to directly query the accounting database to display account data in real-time. Many members are likely to select the option of an online invoice only, which eliminates the need for a paper invoice.

The shopping club system incorporates adequate security to forbid unauthorized data access to unauthorized non-members or members. The entire site for the shopping club system may include extensive and sophisticated internal and external security measures in place (e.g., external security can be a part of the hosting service's support agreement).

An important feature of this shopping club method is that it creates a fullcircle revenue structure. Individuals join the shopping club. They purchase essential services from the shopping club, such as phone, Internet access, and/or other services. Then the customer shops online. Each purchase earns a rebate for the customer. The amounts differ by vendor but they are plainly posted on the shopping club site. The rebate is applied to the member's bill for essential services. When there is a balance after paying for the essential services, the member is issued a rebate check.

This shopping club system is cost effective because it can use new technologies to decrease operating expenses. For example, the shopping club system can use online billing and online customer service. Other cost savings are consolidated monthly billing for multiple services and lower operating costs as a percentage of revenue. The shopping club system's unique incentive programs create an added value to the member that lowers attrition and maximizes the member acquisition expense.

Another advantage of the present invention is that it leverages a powerful computer networked business strategy to lower operating costs and increases revenue potential. The shopping club system targets consumers that use the Internet for buying purposes. For example, customer service operating expenses are dramatically lower for members who are billed online and can be serviced by e-mail instead of phone calls. In addition, online members that utilize the shopping rebates generate valuable customer profiling, which enables the shopping club to help each member realize greater savings in the future. Customer profiling gives the shopping club system a valuable and extensive membership database that includes information about each member, such as identity, income, address, buying patterns, product preferences, etc. This data is a powerful information asset that grows in value as the shopping club's membership base increases.

The present invention has modified the traditional on-line shopping model in a surprising manner. Conventionally, access to online retailers has been available through companies such as e-Bay, Yahoo, etc. These companies provide links to online retailers, but they retain all the commissions and rebates that are paid by the retailer. As mentioned above, the present invention departs from this model because it passes the retailer rebate back to its member to be used for any of the essential services and products. This system effectively uses an on-line shopping portal designed to attract and retain the purchasing loyalty of customers. The shopping club system generates its primary revenues by its monthly services, and the commissions paid by on-line retailers on virtually every on-line purchase are forwarded directly to its members in the form of an “account rebate.”

When entering an online retailer site via the shopping club system's shopping portal, members receive a rebate equal to the percentage indicated next to the retailer's name. This rebate amount has been pre-negotiated by the buyers group as a part of their aggregate shopping power. Members can enjoy this additional savings at an unlimited number of electronic locations or web sites which each present their respective products, which may collectively number into the millions.

One possible example of stores and rebate percentages offered via the shopping rebate program are listed below:

Avon-- 8%
Brookstone-- 4%
Eddie Bauer-- 5%
Fog Dog-- 10%
Hickory Farms-- 10%
KB Kids.com-- 5%
Magazines.com-- 25%
Mattel-- 10%
Osh Kosh B' Gosh-- 10%
REI-- 5%
Spiegel-- 5%
Warner Bros.-- 5%
Barnesandnoble.com-- 5%
Buy.com Video-- 8%
Esprit-- 5%
Hallmark-- 8%
Ice.com-- 15%
Lands' End-- 5%
MarthaStewart.com-- 10%
Office Max-- 4%
PetsMart-- 10%
Sharper Image-- 10%
Walmart-- 3%

Members can also “zero-out” many of their monthly bills by participating in a “referral rebate program”. By sharing the savings, members realize and enjoy savings with other residential or business consumers by referring them to the shopping club system. The referring member earns a percentage of the monthly service revenue attributable to the referred member. This percentage of the monthly service revenue is applied to the bills for the essential services and products.

The shopping club system can attract new customers through at least six cost-effective channels. The first and fastest of these methods for acquiring new members is through acquisition, affiliation or merger with companies that have existing membership bases. There are many companies in the marketplace with large membership bases, ripe for acquisition or affiliation.

A second method of attracting customers to the shopping club system is through direct response information or infomercials hosted by national celebrities that focus on the savings opportunities available through this shopping club system. In order for a television viewer to take advantage of the attractive savings opportunities and rebate programs outlined in the infomercial, they must activate a monthly service through the shopping club system, such as long distance or Internet access. In the preferred embodiment of the shopping club system and method, no other membership fees are required. If desired, the shopping club system can charge membership fees.

Another avenue for acquiring members for the shopping club system is through radio advertising. The radio ads can be purchased outright or a radio company can have a revenue sharing agreement with the shopping group.

Member referrals reduce cash flow requirements for growth. A shopping group tends to create an Internet-based “viral” marketing environment to drive membership growth. Members are encouraged to share daily and weekly e-mail specials with friends and family in order to take advantage of special offers. The commission percentage offered to members for referring other members is probably the greatest incentive the buyer's group offers for bringing in new members.

Independent Telecommunication Agents (“agents”) are commissioned salespeople who represent a client base to find the best telecommunication value and service in the market. These agents represent over $8 billion in annual telecommunication revenue. Agents are looking to offer service packages that create diversity in the marketplace, and that will secure the longest-term commission prospect for them. The shopping club offers that market diversity and long-term commission opportunity. The shopping club's exclusive member benefit programs help businesses reduce their monthly communication expenses creating an easier sale for the agents. Over the past year, the shopping club has attracted a network of more than 750 agents. Revenue from the agents is growing at over twelve percent (12%) per month.

Marketing of the shopping club may also take place through an “affinity” organization. Examples of these organizations are AARP, PTA, GOP, professional associations, churches, and Internet communities. These organizations are continually searching for opportunities to generate revenue. The present invention enables organizations to generate revenue while positioning the essential services as part of their member benefits packages. The specific organization receives a percentage of the monthly service revenue while the member enjoys discount services and rebate opportunities. These members are also enthusiastic about supporting their organizations without making a cash donation.

The data that the shopping club system manages and collects relative to all of its shopping club members has significant value. The shopping club system can maximize this asset in two ways. First, the shopping club may generate future revenue streams by customizing product offerings to specific member profiles. Second, the shopping club may create an additional profit center by mining and marketing the information assets to third parties.

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been shown in the drawings and fully described above with particularity and detail in connection with what is presently deemed to be the most practical and preferred embodiment(s) of the invention, it will be apparent to those of ordinary skill in the art that numerous modifications, including, but not limited to, variations in implementation, form, function and manner of operation, assembly and use may be made, without departing from the principles and concepts of the invention as set forth.

1. A method for reducing periodic service charges associated with essential services and products that are subscribed to by shopping club members, comprising the steps of:
(a) supplying the essential services to shopping club members, through the shopping club;
(b) billing the shopping club members periodically for the essential services received;
(c) directing the shopping club members to a shopping partner, where the shopping club members can make purchases;
(d) receiving rebates from the shopping partner for the purchases made by the shopping club members from the shopping partner; and
(e) applying the rebates received to the billing for the essential services provided.

2. A method as in paragraph 1, further comprising the step of paying the shopping club member a rebate payment if the rebates received exceed the shopping club member's billing for essential services.

3. A method as in paragraph 1, wherein step (c) further comprises the step of directing shopping club members to shopping partner's web sites where the shopping club members make purchases on the web sites.

4. A method as in paragraph 1, wherein step (c) further comprises the step of directing shopping club members to a shopping partner's retail location where the shopping club members make purchases at the retail location.

5. A method as in paragraph 1, wherein step (b) further comprises billing the shopping club members monthly for the essential services

6. A method as in paragraph 1, wherein step (b) further comprises directing shopping club members to shopping partners through the shopping club's web site.

7. A method as in paragraph 1, further comprising the step of supplying essential services that are selected from the group consisting of telephone long distance services, Internet connectivity services, wireless telephone services, satellite television services, cable television services, and grocery discount services.

8. A method for reducing periodic service charges associated with essential services that are supplied by a shopping club, and subscribed to by shopping club members, comprising the steps of:
(a) supplying essential services to shopping club members;
(b) billing the shopping club members periodically for the essential services;
(c) directing shopping club members to shopping partners where the shopping club members make purchases;
(d) receiving rebates from the shopping partner for the purchases made by the shopping club members at the shopping partners;
(e) applying the rebates received from the shopping partners to the billing for the essential services provided through the shopping club; and
(f) paying the shopping club member a payment if the rebates received exceed the shopping club member's billing for essential services.

9. A method for reducing periodic service charges associated with essential services for members of a shopping club, comprising the steps of:
(a) supplying essential services to shopping club members who have been referred to the shopping club by a referring shopping club member;
(b) billing the shopping club members periodically for the essential services;
(c) directing shopping club members to shopping partners where the shopping club members make purchases;
(d) receiving rebates from the shopping partners for the purchases made by the shopping club members at the shopping partners; and
(e) applying a percentage of the rebates received from the retail shopping partners to the referring shopping club member's billing for the essential services provided through the shopping club.

10. A method as in paragraph 9, further comprising the step of paying the shopping club member a payment if the rebates received exceed the shopping club member's billing for essential services.

11. A shopping club system for reducing periodic service charges associated with essential services for members of a shopping club, comprising:
(a) a shopping club which shopping club members can join;
(b) an essential services system, which a shopping club member subscribes to when the shopping club member joins the shopping club, wherein shopping club members are periodically bill for the use of essential services;
(c) a referral system provided by the shopping club, that refers shopping club members to third party shopping services;
(d) an accounting system, controlled by the shopping club, to receive rebates from third party shopping services for purchases made by the shopping club members, wherein the accounting system applies the rebates to shopping club member's bills for essential services.

12. A method for reducing and potentially eliminating a monthly bill for services subscribed to by members of a shopping club, comprising the steps of:
(a) subscribing a shopping club member to a subscriber service that is offered by the shopping club;
(b) directing a shopping club member to a sales partner who provides a rebate to the shopping club for purchases made by the shopping club member;
(c) receiving a rebate from a sales partner for at least one purchase made by the shopping club member; and
(d) applying the rebate from the sales partner as a credit to the shopping club member's periodic bill for subscriber services.

13. A method as in paragraph 1, further comprising the step of sending a payment to shopping club member when rebates received from at least one retailer exceed the shopping club members monthly bill for monthly subscriber services.

14. A method as in paragraph 1, further comprising the step of subscribing to a monthly service that is selected from the group of monthly subscriber services consisting of telephone long distance service, internet connectivity service, wireless telephone service, satellite television service, cable television service, and a grocery discount service.
